(19) United States
(12) Patent Application Publication
(10) Pub. No.: US 2020/0005393 A1
(43) Pub. Date: Jan. 2, 2020

(54) SPECIFIC GUI STRUCTURED FOR APPLICATION DATA ENTRY

(71) Applicant: Confident Financial Solutions, Inc., Boulder, CO (US)

(72) Inventor: Kevin Cawley, Boulder, CO (US)

(21) Appl. No.: 16/452,728

(22) Filed: Jun. 26, 2019

Related U.S. Application Data
(60) Provisional application No. 62/692,392, filed on Jun. 29, 2018.

(51) Int. Cl. G06Q 40/02; G06F 21/31; G06F 9/451; G06F 3/0484; G06F 3/0481; G06F 17/24

(52) U.S. Cl. CPC G06Q 40/025; G06F 21/31; G06F 17/243; G06F 3/0484; G06F 3/0481; G06F 9/451

(57) ABSTRACT

A method of electronically processing a loan application, the method including receiving, via a computer system, identifying information for an applicant for the loan application; matching, in real time and via the computer system, the identifying information with a potential identity within a credit bureau; authenticating, using a two-factor authentication method and the computer system, that the potential identity within the credit bureau is associated with the applicant; and auto-populating the loan application with information from the potential identity within the credit bureau.

### CROSS-REFERENCE TO RELATED APPLICATION

This application claims the benefit of the filing date of, and priority to, U.S. Application No. 62/692,392, filed Jun. 29, 2018 bearing Attorney Docket No. 36333.57PV01, the entire disclosure of which is hereby incorporated herein by reference.

### TECHNICAL FIELD

The present disclosure relates generally to a graphical user interface (“GUI”) that is specifically structured for reducing errors during application data entry which, in combination with an authentication process, allows for a single-session, real-time loan application and approval process.

### BACKGROUND

Conventionally, when a user completes an application for a loan, lease, or the like, the user must manually enter or otherwise provide personal data that is used to match the user with an existing user profile. For example, when applying for a loan, the user provides to a lender—using dialogue boxes—personal information such as his or her social security number, address, work history, phone number, date of birth, etc. in a first lender-user interactive session. The lender receives the personal information and attempts to match the provided personal information with an existing user profile. When the user makes an error or when the personal information is incomplete, the loan application cannot be completed because a match cannot be made with the user profile or the confidence in the match is low. The receipt of the personal information and attempted matching by the lender may take hours or days. First, the lender receives electronic text provided via the dialogue boxes or transfer of hand-written responses into an electronic text format. The electronic text is then compared to data listed in the user profile. For example, the user may provide an address of “Two Fork Road” when the data listed in the user profile is “Two Forks Road.” Conventionally, it must be determined whether the provided address is the same as the addresses listed in the user profile. If not, and as in this example, it must then be determined whether the data provided is close enough to the listed address. The comparison and the determination take time, increase processing load on the systems performing the comparison and determination, and also increase memory requirements due to the storage of the data received from the user. Often, by the time the lender determines that additional information or corrections are required to successfully match the user with the user profile, the user is no longer actively engaged with the application process. This time gap between the entering of the personal information and the determination that additional information is needed from the user results in a need for a second lender-user interaction session. Often, the effort required by the user to initiate the second lender-user interaction session reduces the likelihood that the user will reengage with the lender to complete the application. Alternatively, the user may have already secured funding through a different entity during this time gap.

### BRIEF DESCRIPTION OF THE DRAWINGS

FIG. 1 is a diagrammatic illustration of a system according to an example embodiment, the system including a remote user device.

FIG. 2 is a diagrammatic illustration of the remote user device of FIG. 1, according to an example embodiment, the remote user device including a graphical user interface (“GUI”).

FIG. 3 is a flow chart illustration of a method of operating the system of FIG. 1, according to an example embodiment.

FIG. 4 is an illustration of a window that is displayed on the GUI of FIG. 2, according to one embodiment.

FIG. 5 is an illustration of another window that is displayed on the GUI of FIG. 2, according to one embodiment.

FIG. 6 is an illustration of yet another window that is displayed on the GUI of FIG. 2, according to one embodiment.

FIG. 7 is an illustration of yet another window that is displayed on the GUI of FIG. 2, according to one embodiment.

FIG. 8 is an illustration of yet another window that is displayed on the GUI of FIG. 2, according to one embodiment.

FIG. 9 is an illustration of yet another window that is displayed on the GUI of FIG. 2, according to one embodiment.

FIG. 10 illustrates a table used by the system of FIG. 1, according to an example embodiment.

FIGS. 11-13 together illustrate another table used by the system of FIG. 1, according to an example embodiment.

FIG. 14 is an illustration of yet another window that is displayed on the GUI of FIG. 2, according to one embodiment.

FIG. 15 is an illustration of yet another window that is displayed on the GUI of FIG. 2, according to one embodiment.

FIG. 16 is an illustration of yet another window that is displayed on the GUI of FIG. 2, according to one embodiment.

FIG. 17 is an illustration of yet another window that is displayed on the GUI of FIG. 2, according to one embodiment.

FIG. 18 is an illustration of yet another window that is displayed on the GUI of FIG. 2, according to one embodiment.

FIG. 19 is an illustration of yet another window that is displayed on the GUI of FIG. 2, according to one embodiment.

FIG. 20 is an illustration of yet another window that is displayed on the GUI of FIG. 2, according to one embodiment.

FIG. 21 is an illustration of yet another window that is displayed on the GUI of FIG. 2, according to one embodiment.

FIG. 22 is a diagrammatic illustration of a node for implementing one or more example embodiments of the present disclosure, according to an example embodiment.

### DETAILED DESCRIPTION

The following disclosure provides many different embodiments or examples. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

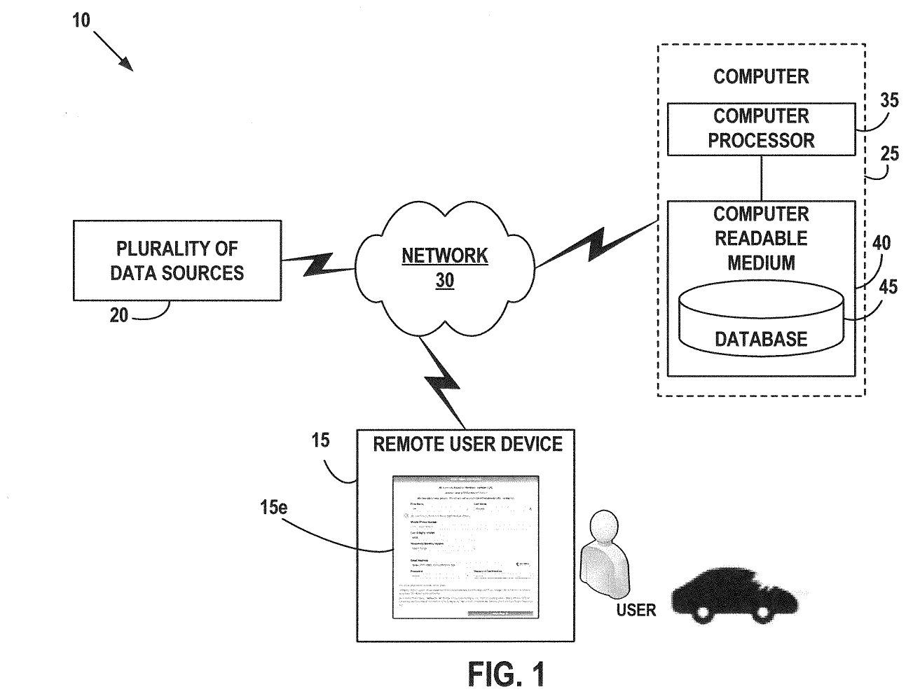

A system generally referred to by the reference numeral 10 as illustrated in FIG. 1 provides a GUI that is specifically structured for reducing errors during application data entry which, in combination with an authentication process, allows for a single-session, real-time loan application and approval process.

In an example embodiment, as illustrated in FIG. 1, the system 10 includes one or more remote user devices 15; a plurality of data sources 20; and a computer 25 that are operably coupled together, and in communication via a network 30. Generally, the computer 25 includes a computer processor 35 and a computer readable medium 40 operably coupled thereto. Instructions accessible to, and executable by, the computer processor 35 are stored on the computer readable medium 40. A database 45 is also stored in the computer readable medium 40.

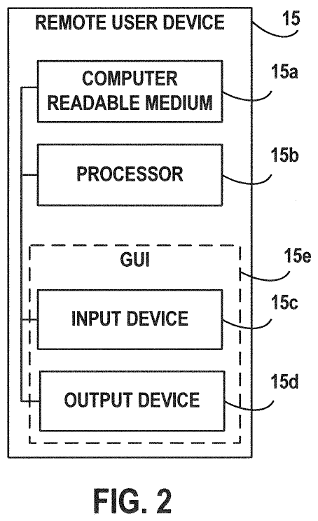

In an example embodiment, as illustrated in FIG. 2 with continuing reference to FIG. 1, the remote user device 15 includes a computer readable medium 15a, a processor 15b, an input device 15c, and an output device 15d. In an example embodiment, instructions accessible to, and executable by, the processor 15b are stored in the computer readable medium 15a. In an example embodiment, the input device 15c is a keyboard, mouse, microphone, or other device coupled to the remote user device 15 that sends instructions to the remote user device 15. In some embodiments, the remote user device 15 includes a graphical user interface (“GUI”) 15e that serves as the input device 15c and the output device 15d. In some embodiments, the GUI 15e is in the form of, or includes, one or more digital displays, one or more liquid crystal displays, one or more cathode ray tube monitors, and/or any combination thereof. In an example embodiment, the output device 15d includes a graphical display, a printer, a plotter, and/or any combination thereof. In an example embodiment, the input device 15c is the output device 15d, and the output device 15d is the input device 15c. In several example embodiments, the remote user device 15 is, or includes, a telephone, a personal computer, a personal digital assistant, a cellular telephone, other types of telecommunications devices, other types of computing devices, and/or any combination thereof. In several example embodiments, the remote user device 15 includes a plurality of remote user devices. In an example embodiment, web browser software is stored in the computer readable medium 15a.

In an example embodiment, the computer 25 is a computing device and also includes an input device and an output device similar to the input device 15c and the output device 15d of the remote user device 15. However, any type of input device and output device may be used. In one or more example embodiments, the computer 25 includes or is operably coupled to an application or an application server, which in several example embodiments includes and/or executes one or more web-based programs, Intranet-based programs, and/or any combination thereof. In an example embodiment, the application includes a computer program including a plurality of instructions, data, and/or any combination thereof. In an example embodiment, the application is written in, for example, HyperText Markup Language (HTML), Cascading Style Sheets (CSS), JavaScript, Extensible Markup Language (XML), asynchronous JavaScript and XML (Ajax), and/or any combination thereof. In an example embodiment, the application is a web-based application written in, for example, Java or Adobe Flex, which pulls real-time information from another computer and/or the plurality of data sources 20. In an example embodiment, the application pulls real-time information from the plurality of data sources 20, upon the execution, opening or start-up of the application. In an example embodiment, the application is stored on the computer readable medium 40 and/or in the database 45. In an example embodiment, the computer 25 may include a specially designed code, such as for example SAS code and/or UNIX. In an example embodiment, the SAS code allows communication with an external database, such as a database associated with one or more of the plurality of data sources 20.

In an example embodiment, the network 30 includes the Internet, one or more local area networks, one or more wide area networks, one or more cellular networks, one or more wireless networks, one or more voice networks, one or more data networks, one or more communication systems, and/or any combination thereof.

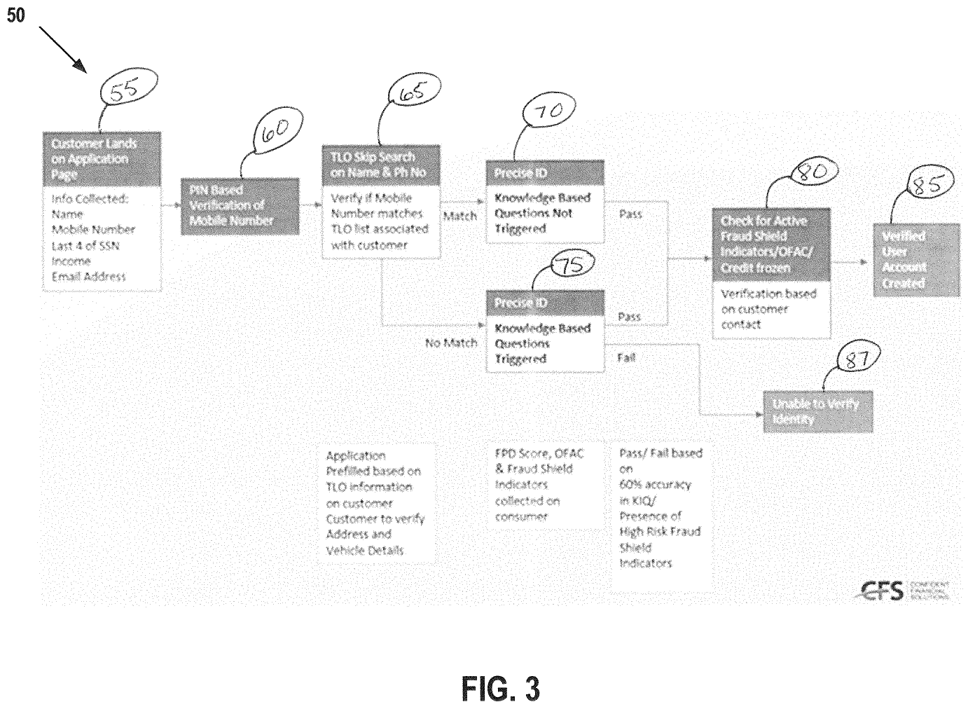

In an example embodiment, as illustrated in FIG. 3 with continuing reference to FIGS. 1-2, a flow chart 50 detailing the process flow for creating a verified user account includes steps 55, 60, 65, 70, 75, 80, 85, and 87. In one embodiment, applications for credit are collected through the GUI 15e by the user, or person who is applying for the loan. However, in some embodiments, applications may be entered via the GUI 15e by other users with information provided and approval of submission given over the phone by customers.

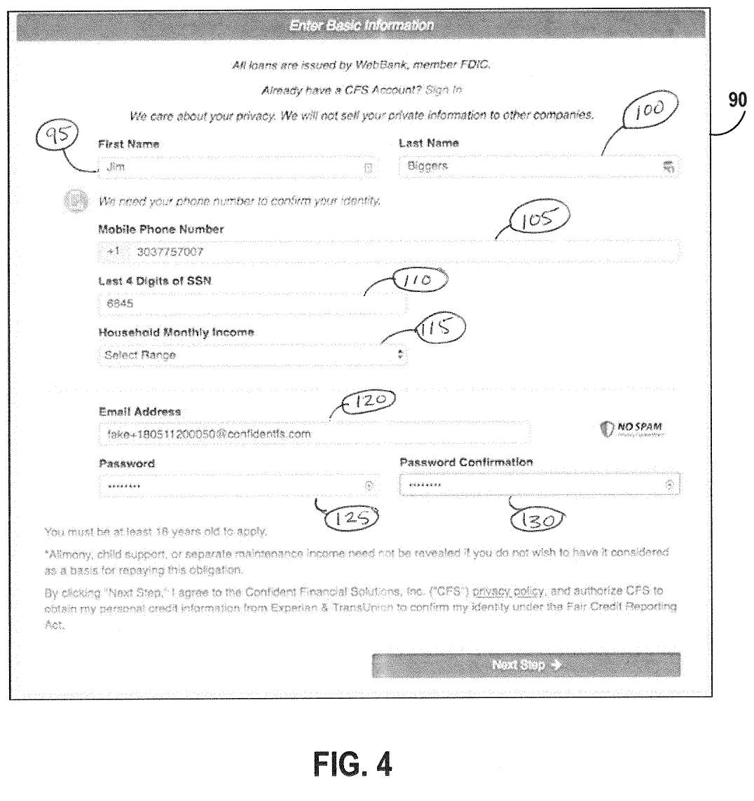

At the step 55, and using a window, the user is asked to enter identifying data that includes his or her first name, last name, last 4 digits of his or her social security number or other identification number associated with the user, and mobile phone number. An income range is also requested in the window. FIG. 4 illustrates a window 90 that includes or displays a first dialogue box 95, a second dialogue box 100, a third dialogue box 105, and a fourth dialogue box 110. Moreover, the window 90 displays a graphical control element 115 such as a drop-down box. Generally, the first dialogue box 95 is configured to receive a first name of the user; the second dialogue box 100 is configured to receive a last name of the user; the third dialogue box 105 is configured to receive a user phone number; the fourth dialogue box 110 is configured to receive a portion of a personal identification number associated with the user; and the graphical control element 115 is configured to display a list of income ranges. Generally, the window 90 also displays dialogue boxes to receive user contact data, such as an email address dialogue box 120, a password dialogue box 125 and a password confirmation dialogue box 130. The system 10 uses the identifying data to match the user with a user profile that is listed in one or more external data sources, such as the plurality of data sources 20. In some embodiments, the plurality of data sources 20 includes a credit agency such as Experian or TransUnion, or other repositories of public or proprietary data. In some examples, the user profile is a credit profile or other profile that reflects the creditworthiness of the user. If an exact match on the user is not found based on the information collected in the window 90, then additional information, such as a date of birth for the user, an address, a portion of an address, etc. is gathered from the user in another window. In some embodiments, after the system 10 receives the data from the window 90 but prior to completing the two-factor authentication method, the user is considered “provisionally identified.”

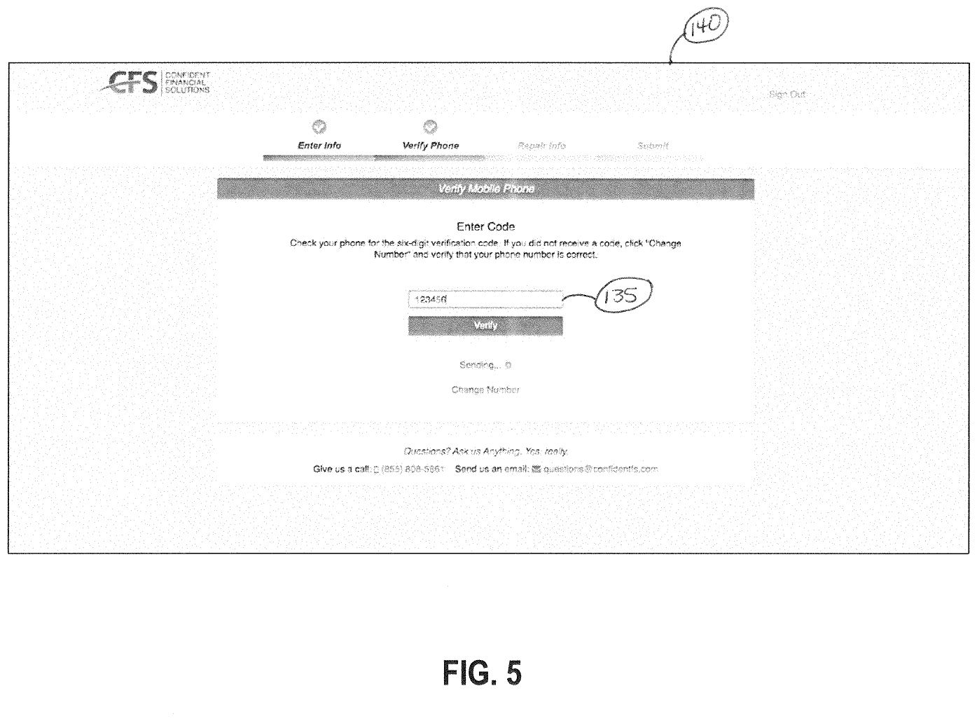

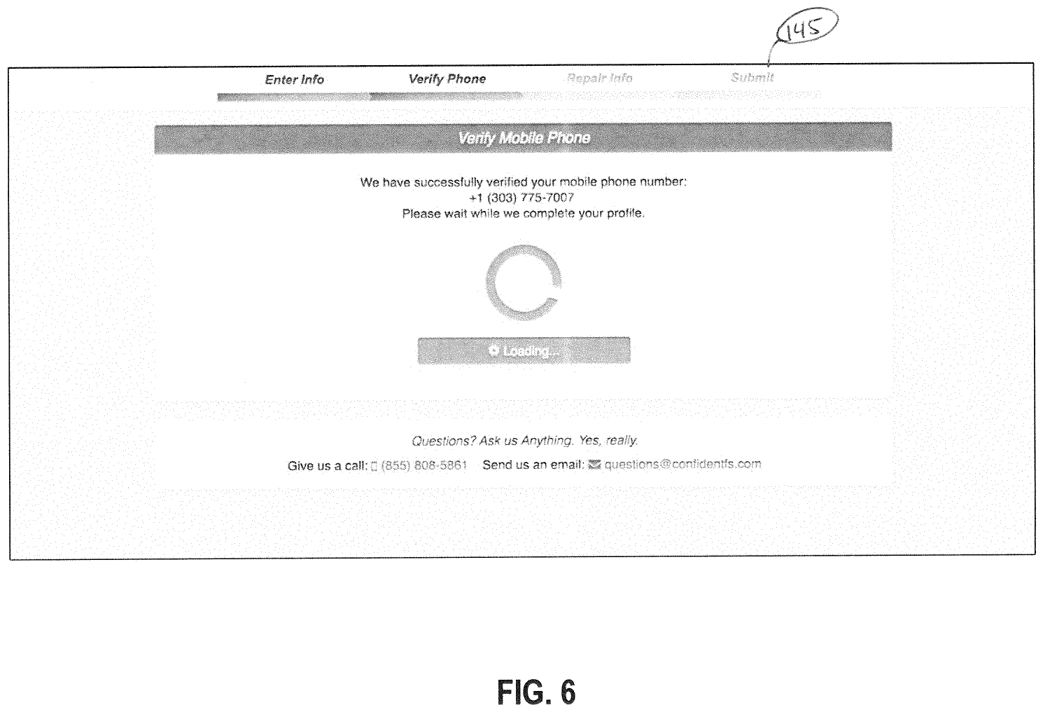

Referring back to FIG. 3 and at steps 60 and 65, the user's mobile number is verified using a two-factor authentication method. In some embodiments, a skip tracing algorithm, such as provided by TransUnion, TLOxp, is used to match the mobile number to the other pieces of identifying information that the user provided via the window 90 and to verify that the mobile phone, or remote user device 15 belongs to the user. The search via TLOxp also identifies address, date of birth and vehicle details for the user. These outputs (excluding vehicle details) are used to query Precise ID. The mobile phone number is then validated through a text based PIN sent to the remote user device 15, to ensure the customer has the device 15 with him or her. As illustrated in FIG. 5, the user must key in the PIN into a dialogue box 135 included in a window 140 displayed on the GUI 15e to continue with the account creation process. After entering the PIN in the dialogue box 135, and as illustrated in the window 145 of FIG. 6, the system 10 verifies the mobile phone number and attempts to complete the user account. In most embodiments, the system 10 does not allow for multiple customers to have the same mobile phone number.

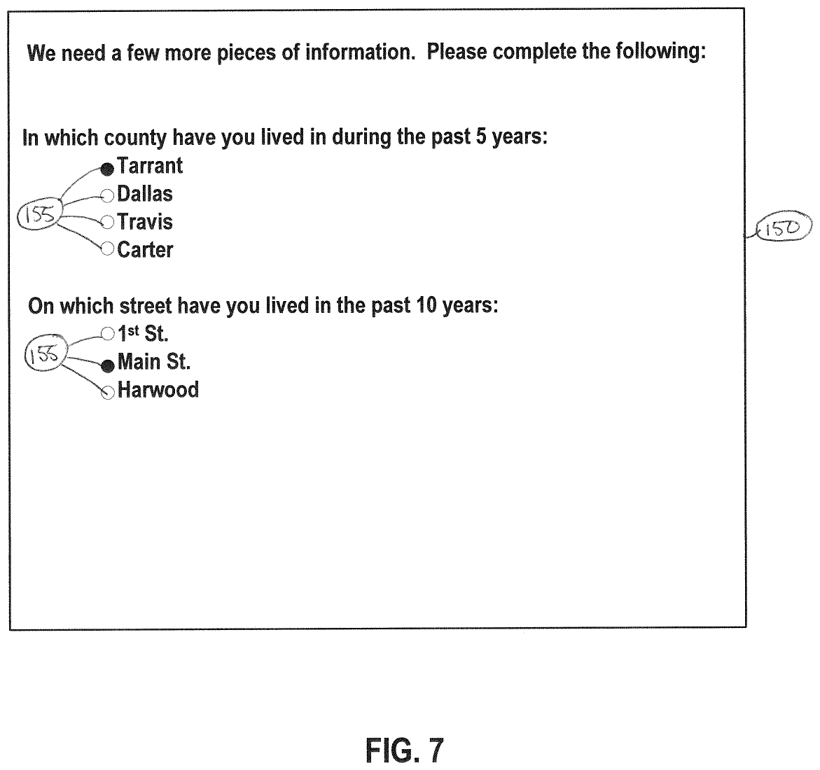

Referring back to FIG. 3 and as detailed in steps 70 and 75, when the mobile number provided by the user matches the mobile number identified by TLOxp as being associated with the user, then knowledge based questions are not triggered. However, when the mobile number does not match the mobile number identified by TLOxp as being associated with the user, then knowledge based questions are triggered to verify the identity of the user. For example and as illustrated in FIG. 7, a window 150 is displayed that presents one or more questions along with a selection of answers. In some embodiments, each answer is associated with a radio button or other selection button 155. The user can select one or more of the selection buttons 155 to answer the knowledge based questions. In some embodiments, the knowledge based questions are triggered via Precise ID. If the user fails the knowledge based questions at step 75, then it is determined that the identity of the user cannot be verified at step 87. The presentation of the window 150 during the application process or method that is detailed in the flow chart 50 occurs within less than 10 minutes, less than 5 minutes, less than 1 minutes, and/or less than 30 seconds after the system 10 determines that the phone number listed by the user in the window 90 does not match the mobile number identified by TLOxp as being associated with the user. Thus, any further information required by the user to correctly match the user to the user profile is provided in a single lender-user interaction. In some embodiments, the application process includes auto-populating the loan application with information accessible from the credit bureaus. Moreover, the further information provided may be used in step 80 to check for fraudulent activities, etc. as detailed in the step 80. In some embodiments, after the two-factor authentication method is completed or after the two-factor authentication method is completed and after the user selects a vehicle from the vehicle list, the user is considered to have his or her identity confirmed.

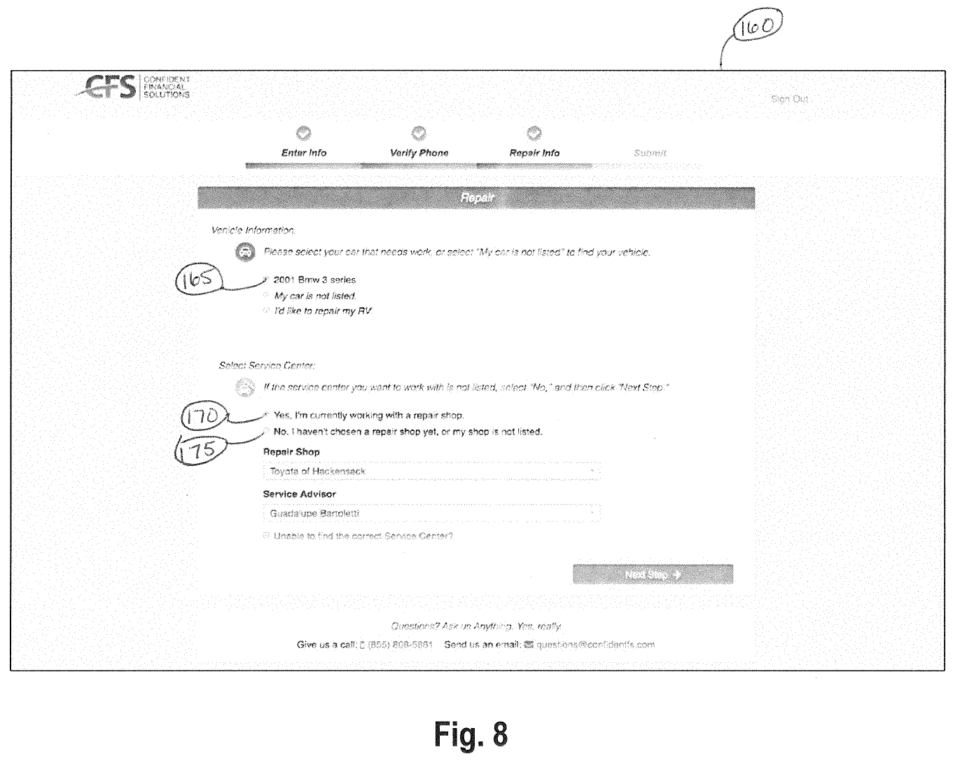

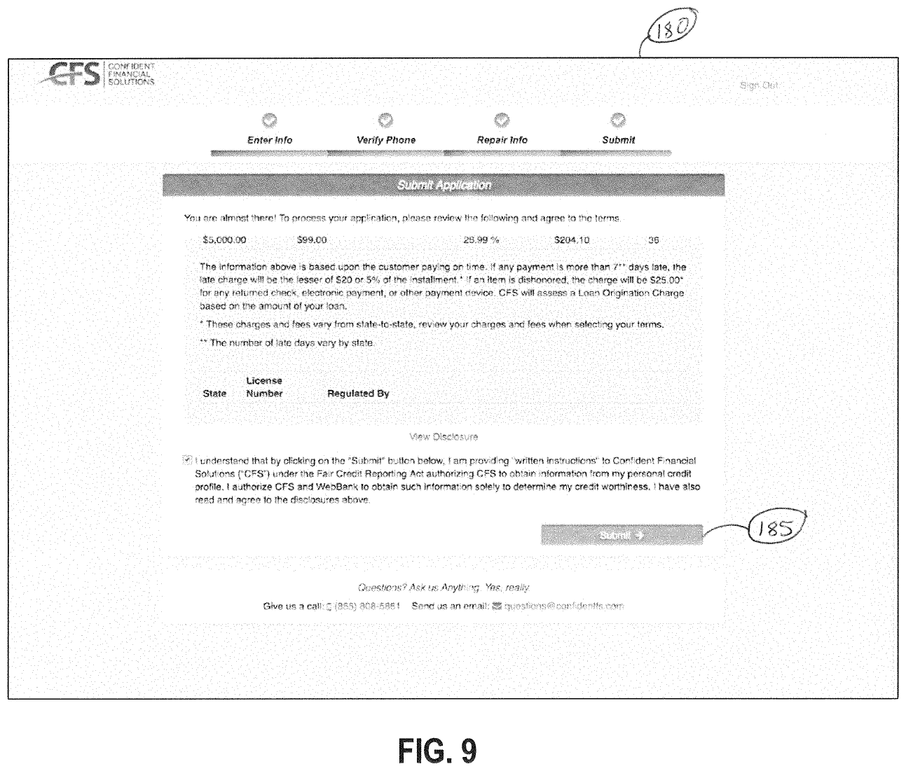

In an example embodiment, as illustrated in FIG. 8, the system 10 displays a window 160 listing the vehicles that are associated with the user profile using the output of the TLO search, which includes vehicle details associated with the identified customer profile. The user must select, via radio button 165 for example, the vehicle on which they want to get a repair from the list of vehicles matched to their identity. If the vehicle for repair is not on the list, the consumer must enter the make, model and year of the vehicle they are getting repaired. Generally, the terms consumer, customer, and applicant are interchangeable. That is, after the user is located in the datasets searched via TLOxp, data for all vehicles associated with the user is presented to the user via the window 160. Assuming the user selects one of the presented vehicles, a credit inquiry can be run on the user. Moreover, the user can indicate, via a radio button 170 for example, if he or she is currently working with a repair shop or via radio button 175 for example, if he or she hasn't chosen a repair shop or the repair shop that he or she is working with is not listed. When the user borrower does not have a preferred Auto Repair Shop, he or she can elect use a virtual payment card that is accepted at any authorized Repair Shop. In some embodiments, the system 10 uses the user's home address to present the borrower with a list of partner shops in proximity and sorted by distance. The user selects from this list. In some embodiments, and when the user is not working with a partner shop, the system 10 generates a virtual credit card. After receiving information from the user via the window 160, the system 10 displays a window 180 in which the user agrees to the terms and indicates that they want to submit the application via an input button 185 as illustrated in FIG. 9.

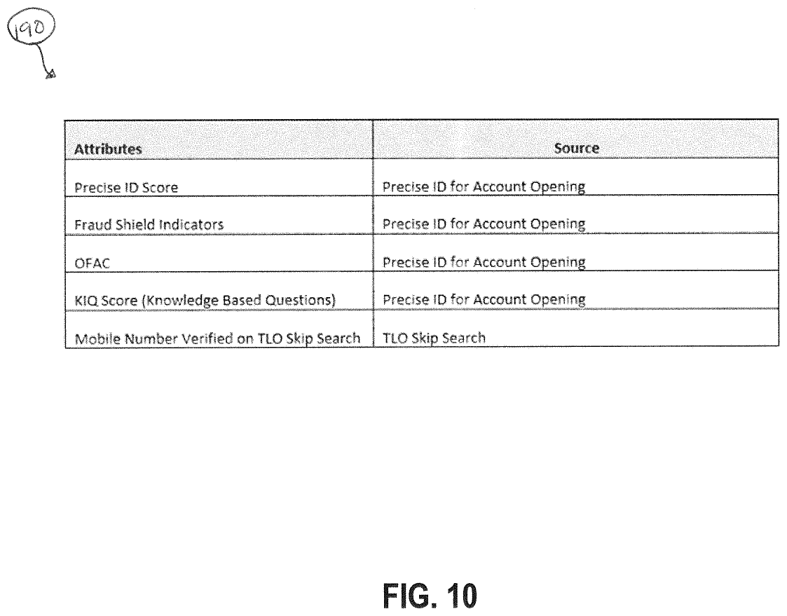

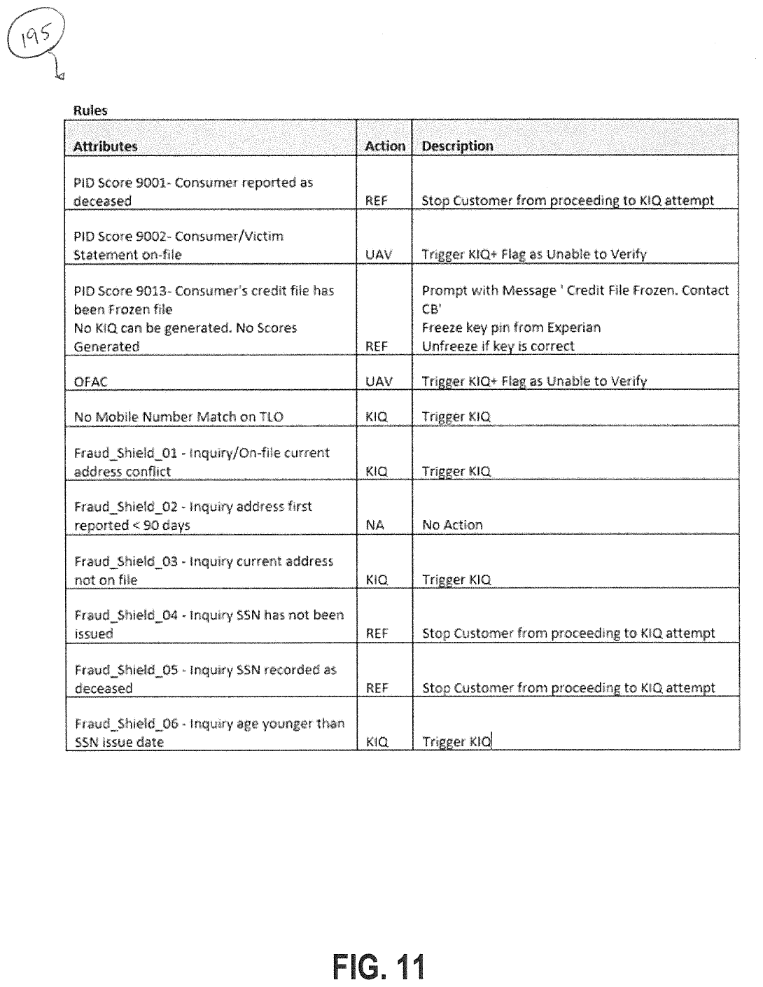

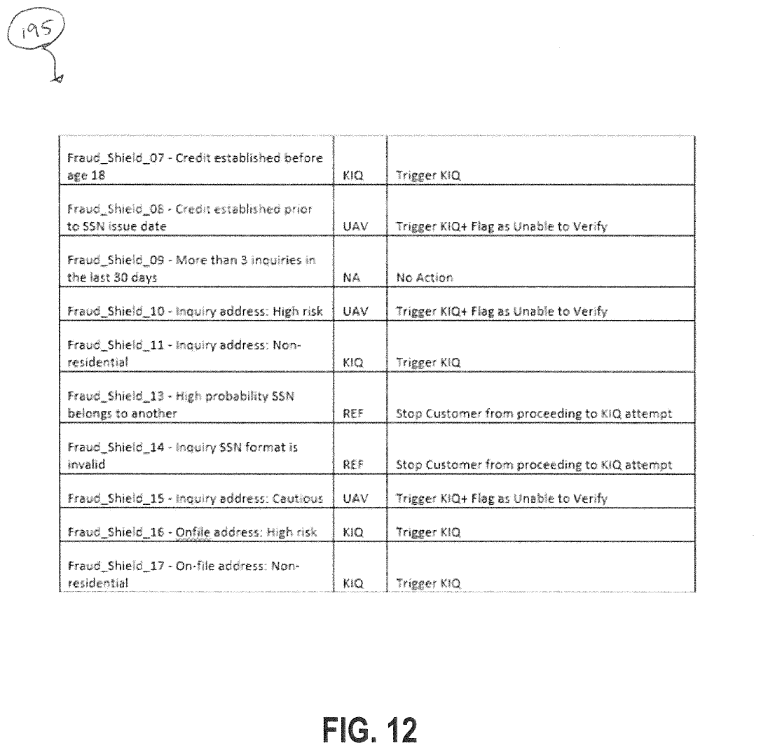

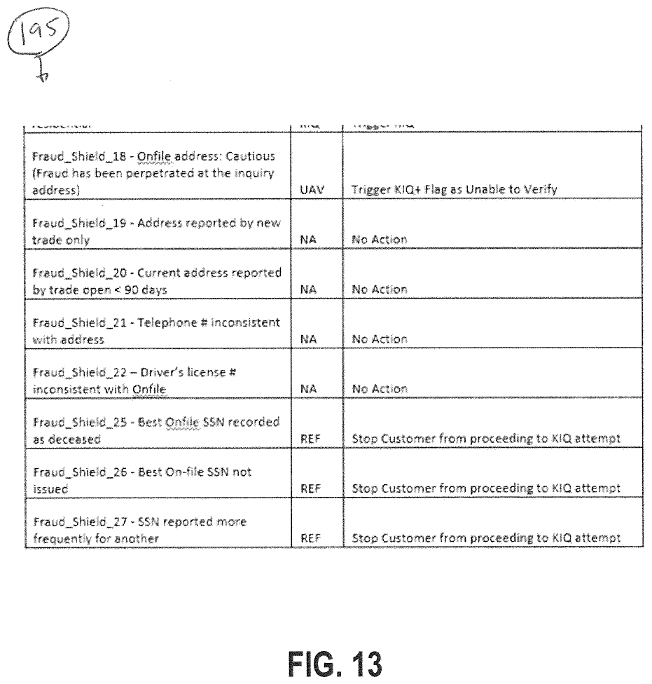

At the step 80, which may occur simultaneously with the step 75, the system 10 checks whether the user is listed on a specific list, such as the Specially Designated Nationals And Blocked Persons List, how the user responses compare against a fraud shield indicator, and/or whether the user has “frozen credit.” Using the identifying data and additional user information collected via TLOxp or similar, the system 10 collects fraud scores and other compliance related triggers. Users with a low match score on their mobile verification or those with medium risk fraud triggers on their Precise ID profile are prompted with knowledge based questions and they must get at least 60% answers correct (60% KIQ score) to successfully authenticate themselves. For example, another window similar to the window 150 may be presented to the user or the responses received from the user via the radio buttons 155 in the window 150 may be used to determine whether the user can successfully authenticate themselves. A user account is flagged based on their level of fraud or compliance risk and a recommended course of action is followed, as described in the table 190 of FIG. 10 and the table 195 of FIGS. 11-13. In the table 195, “Trigger KIQ” represents presenting to the user knowledge based questions via the window 150 and “Unable to Verify” represents flagging the application as unable to verify within the system 10. In these situations, a loan operations specialist may contact these consumers to verify additional pieces of information before proceeding. In some embodiments, users are allowed two attempts in a 24-hour period and a maximum of 10 attempts in total. Based on the Precise ID data, in the following cases customer identity is verified manually by the Loans Operations Specialist before credit is extended:
Matches against Specially Designated Nationals And Blocked Persons List such as the list provided by the Office of Foreign Assets Control. The matched files are flagged and further investigation is done before credit is extended in such cases. If a true match is identified, the Bank's BSA Officer is notified, the application is declined and adverse action is provided.
Consumers with frozen credit files are contacted prior to extension of credit.
Customers with high risk fraud indicators on their files are also flagged within during the account creation and CIP process the system and further investigation is required by the Loan Operations Specialist before credit is extended in such cases. The high-risk fraud indicators include bureau-based fraud indicators provided within Precise ID or CFS internal red-flags.

In cases where there are extreme high-risk fraud indicators on the consumer's credit profile or the customer's identity cannot be verified through the customer identification process, then the system 10 does not allow the user to submit their application for credit. Such users are prompted with a message on the GUI 15e stating that their identity cannot be verified. The application for credit has not been submitted at this point.

At step 85, and if the user passes at the step 80, then a verified user account is created. Once a verified user account has been established within the system 10, the user can proceed to applying for a loan within the system 10. Once the user account has been created successfully and the customer has agreed to the terms of the Disclosure Statement, the user submits their application for credit. The credit decisioning is done systematically based on the bureau data from Experian—which is considered the auto-population of the loan application—and other user-input application data, such as service center type chosen and the state of customer residence. In some embodiments, an API based model deployment platform is used for credit decisioning. The credit decision is then rendered, final approval status is determined, and tier of the customer is determined. This decision is then displayed to the applicant via the GUI 15e.

During the credit decisioning process, multiple statuses are used to ensure each application is tracked in accordance with predetermined policies and to support efficient workflow. These include “Decision Statuses” and “Final Statuses.” “Decision statuses” include declined, approved, and pending verification. Declined is when an application has been evaluated by the applicable strategy and determined to not qualify for the requested loan. An adverse action letter will be sent to the customer via email at the time the application is declined. Approved is when a submitted application has been evaluated by the applicable strategy and determined to qualify for the requested loan. Pending Verification is when a submitted application where showing a fraud or other indicator has been received from the Credit Bureau and requires additional verification from the customer before a final decision can be made. Final statuses include Cancelled, Withdrawn, Doc Signed, and Funded. An application is moved to a status of Cancelled after 30 days from application date if approved but there has been no communication indicating that a repair to be financed by a CFS loan has been started. If there has been communication indicating that a repair to be financed has been started, the application is cancelled after 45 days from application date. An application is moved to a status of Withdrawn if customer is approved but makes a decision to not accept the final loan terms. An application is moved to a status of Doc Signed when the customer indicates they accept the loan terms and has signed the loan agreement. An application is moved to Funded when the dealership submits all required documentation and sends the signed copy of the repair order, and funds have been transferred via ACH.

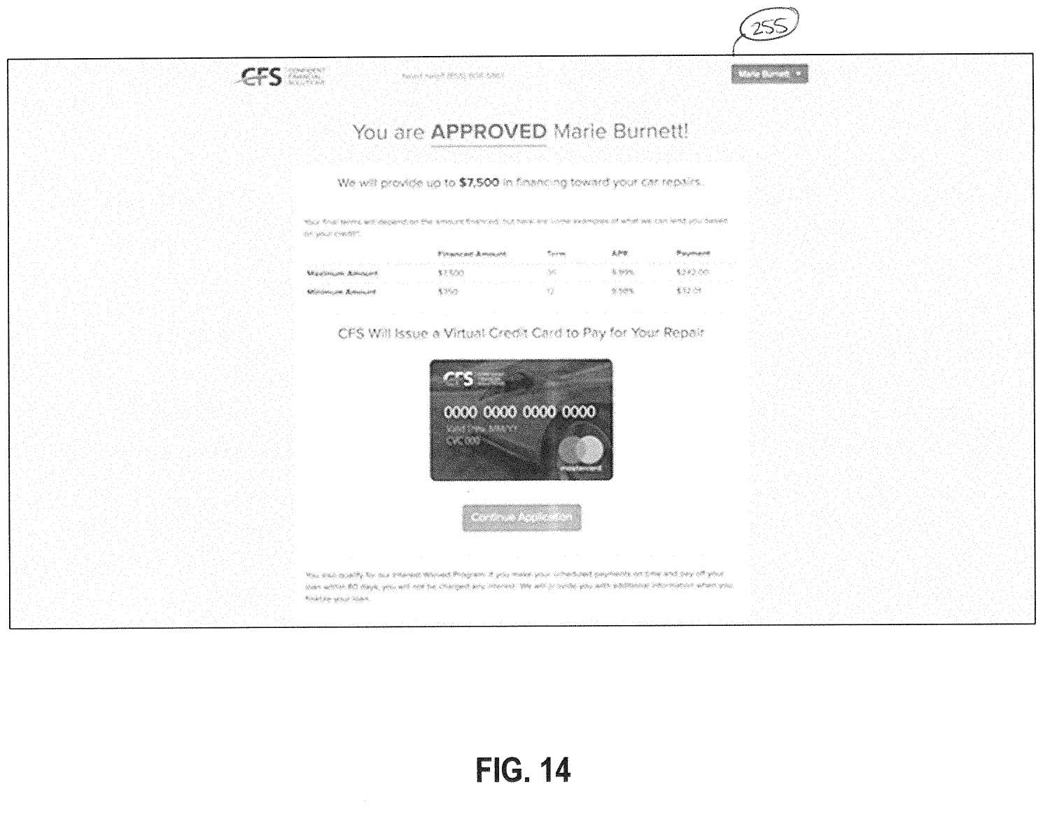

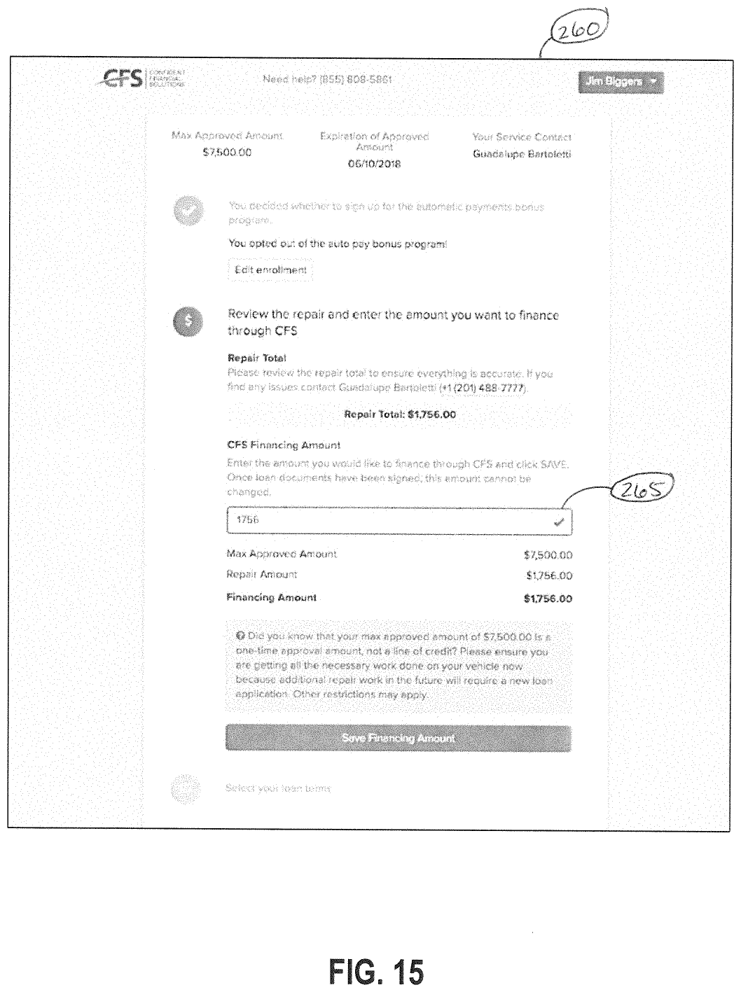

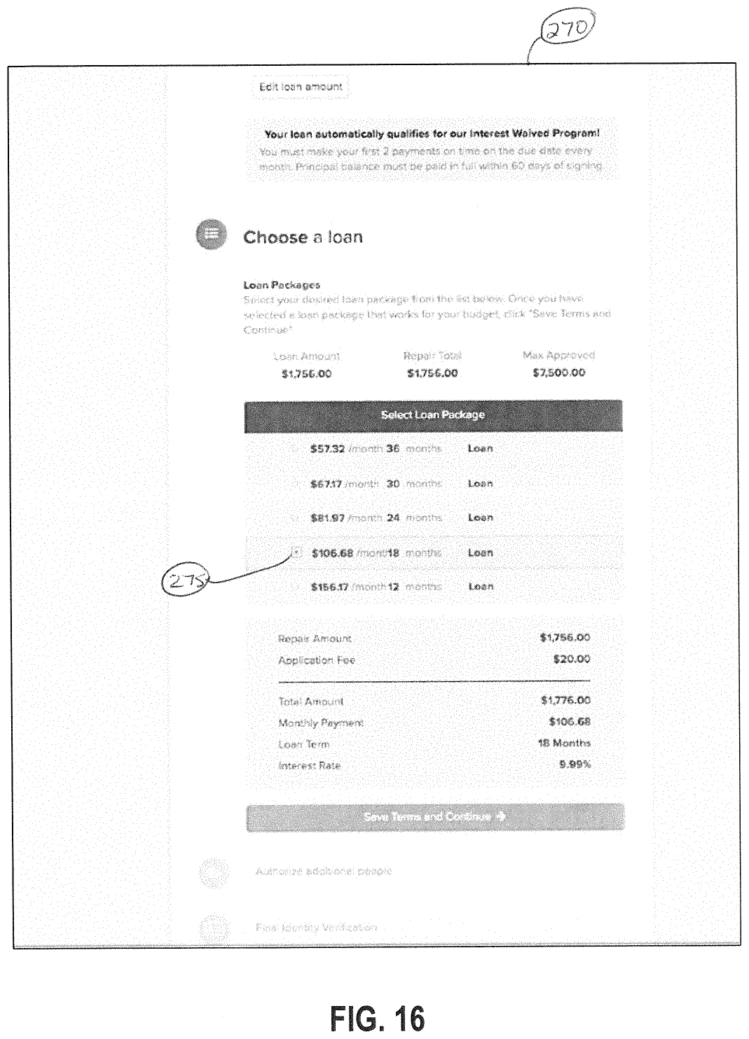

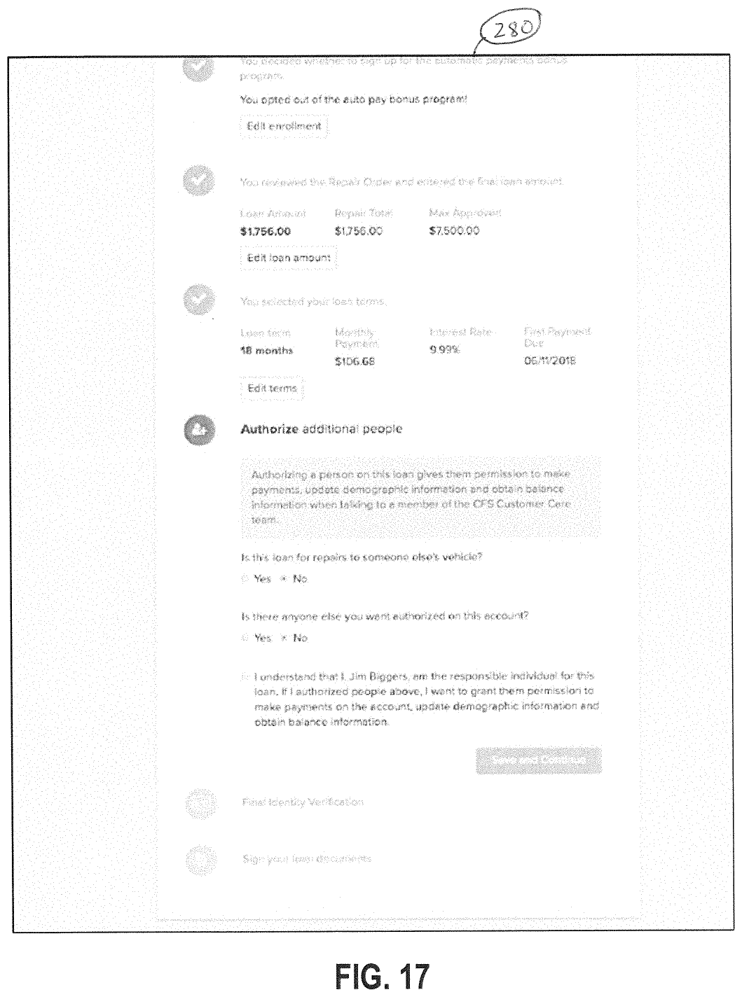

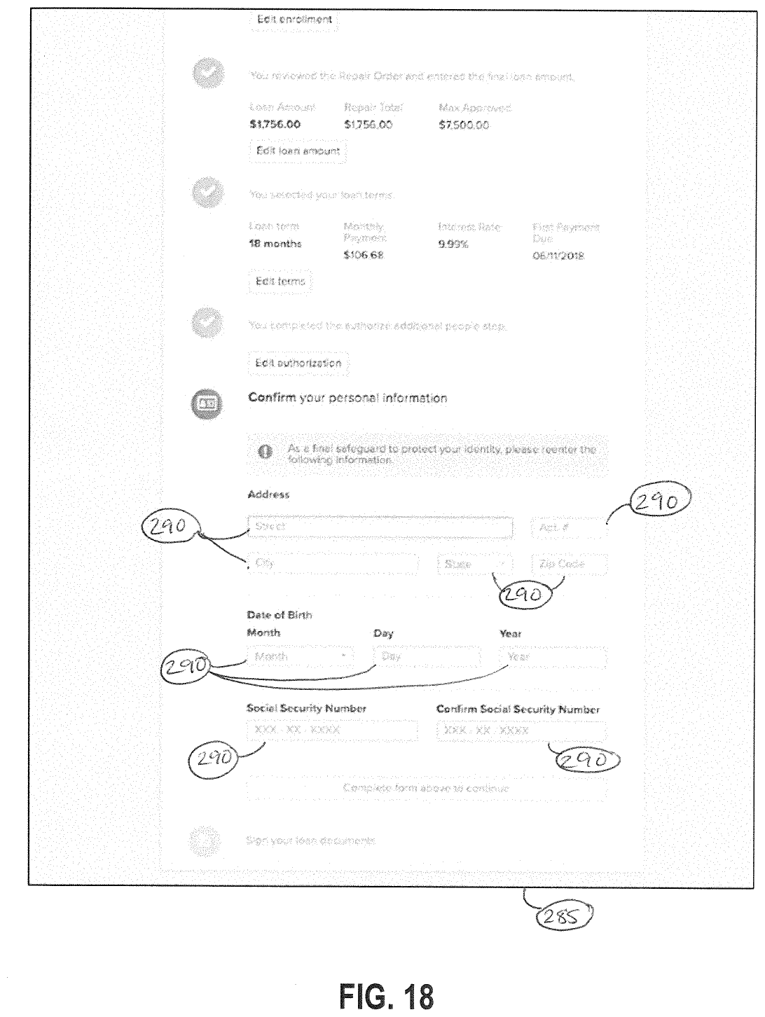

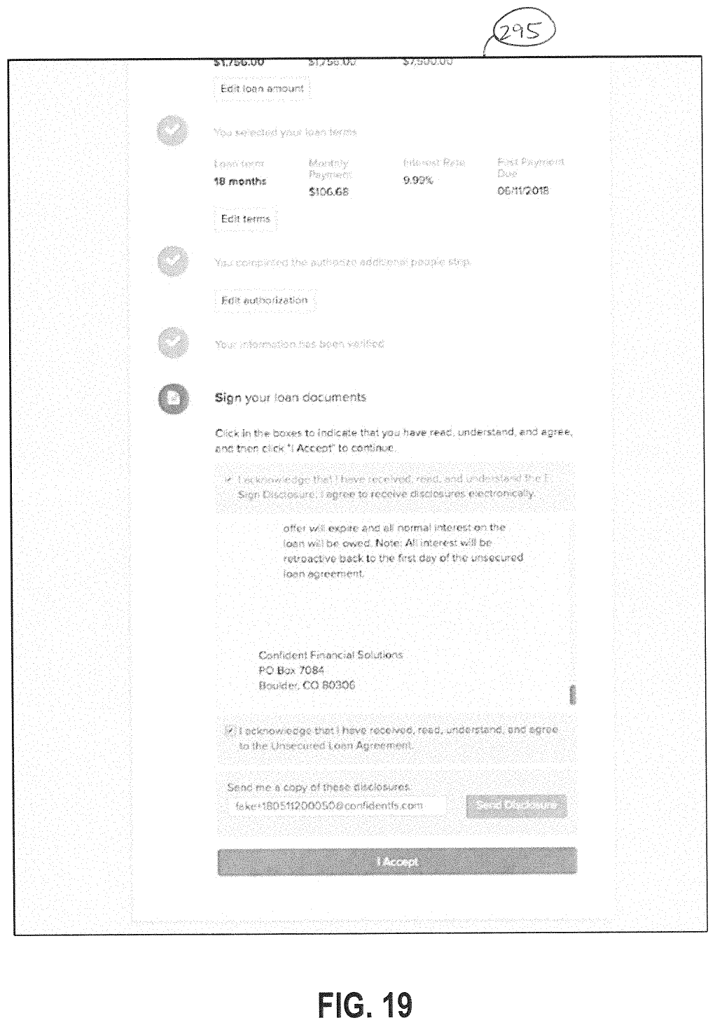

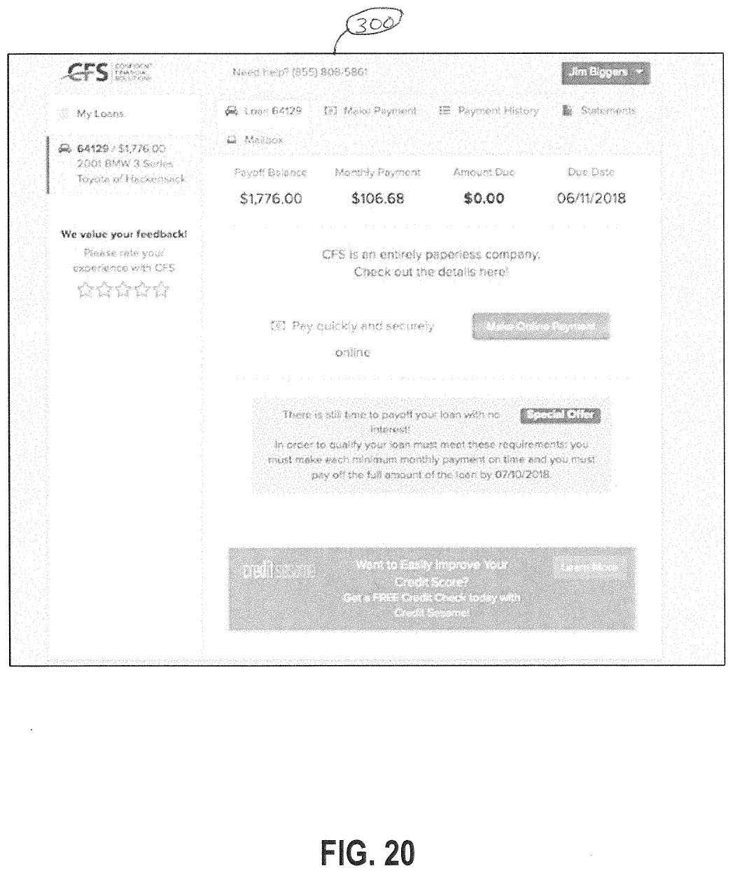

When the user is approved, the max approved amount for the loan is displayed to the customer as illustrated in a window 255 displayed on the GUI 15e in FIG. 14. In a window 260 displayed on the GUI 15e and as illustrated in FIG. 15, the user can choose via a dialogue box 265 the amount to be financed. Once the customer chooses the amount they want to finance based on the repair order amount, they can select the loan terms based on the options available to them. For example and as illustrated in a window 270 displayed on the GUI 15e in FIG. 16, the user can select via a radio button 275 or otherwise, loan terms. Using a window 280 illustrated in FIG. 17, the user can authorize additional people. Using a window 285 illustrated in FIG. 18, the user inputs their full address, full social security number, and date of birth using dialogue boxes 290. These pieces of information are verified against the outputs of TLOxp. If there is a mismatch between the customer input details and the information gathered from TLOxp, then the customer identity is verified manually by the Loans Operations Specialist before credit is extended. However, the request for the full address, full social security number, and date of birth after the approval is different from the request for the full address, full social security number, and date of birth prior to approval as the user is more likely to provide these pieces of information and/or take the time to enter data into the dialogue boxes 290 when user has already been notified of their loan approval. After a final review of the loan terms, customer views and e-signs the Unsecured Loan Agreement as illustrated in a window 295 in FIG. 19. The user or customer will be prompted to set up monthly payments via a window 300 illustrated in FIG. 20. Generally, the customer has 30 days to sign the loan documents post approval.

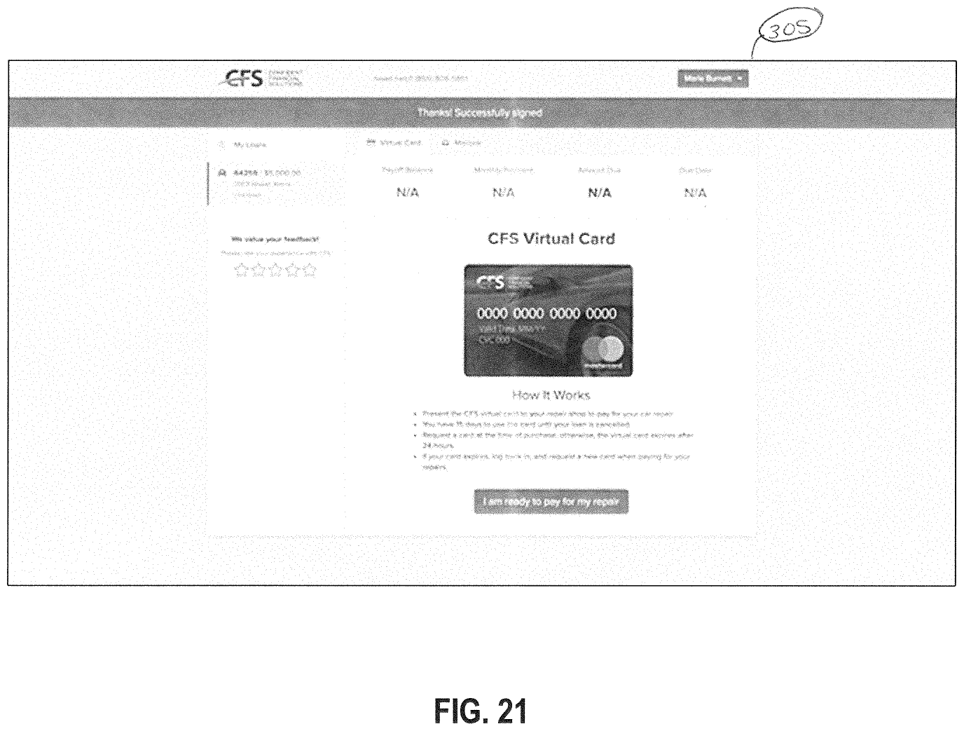

In some embodiments, the funds are distributed via a virtual card that is not activated until the user is ready to pay the repair shop. For example and as illustrated in the window 305 of FIG. 21, the user can indicate via an input button 310 that he or she is ready to pay for his or her repair. Once confirming that he or she wants to activate the virtual card, the user has 24 hours to use the virtual card. After 24 hours, a new card number is generated. With the virtual card, on card swipe the underlying credit card network calls the system's 10 API to authorize the transaction. The system 10 confirms that the customer has been approved, the amount is not greater than the maximum approval (and more than our minimal amount) and that the merchant is valid and authorized.

In some embodiments, any one or more of the steps 55, 60, 65, 70 or 75, 80, and 85 are completed within a single online session that has a duration of less than 20 minutes, less than 10 minutes, less than 7 minutes, and/or less than 5 minutes. However, in some embodiments, the single online session also includes making a decision as to whether a loan will be approved, notification of the approval to the user, and distribution of funds. In some embodiments, a single online session is an experience by the user that involves the creation of an account via supplying a user password and a user identifier or contact information but does not have a duration that requires the user to login to his or her account by supplying his or her user password and user identifier or contact information. That is, conventionally, when the duration of an online process extends a predetermined period of time or when there is inactivity by the user for a predetermined period of time, the user is logged off of his or her account. To access his or her account, the user must login. In some embodiments, with a single online session, the user is not logged off due to inactivity and thus the user remains logged in through the steps of account creation to the distribution of funds or at least notification of approval of the loan.

In some embodiments, the system 10 makes getting to loan approval in the auto-space as simple and fast as possible with minimal data entry and friction to the consumer. Using just 3 pieces of information on the consumer (in most cases), the process enables the customer identity to be verified, vehicle information be pulled, and the credit file of the user to be identified. It minimizes the manual verification without compromising on accuracy of information. There is reduction of manual data entry errors. It also helps identify a unique fraud risk group. Contrary to conventional loan application process, the system 10 can easily attach or associate the consumer to the vehicle. The process also helps identify a segment with high fraud risk based on whether the mobile phone that the consumer possesses actually belongs to them. In some embodiments, the closed set (e.g., name, last four digits of SSN and phone number) of information required by the user to identify the user eliminates manual entry therefore reducing the number of potential errors. Thus, manual verification of the link between the user and the user profile is eliminated. The ability to quickly link a credit profile to a consumer based on a closed set of data reduces the errors and accuracy of the process. This process solves the issue of online identity verification for credit application by using a mobile number. This process is simpler, quicker, faster, and less error-prone.

In one embodiment, the system 10 and/or methods disclosed operate in a non-conventional and non-generic way to ensure that the customer's identity is verified in a manner that is more secure than the conventional verification processes employed by conventional lenders. Specifically, lenders generally require the user to provide a voluminous amount of information using dialogue boxes or traditional paper applications to identify the user profile with the personal data submitted and to verify that the person that provided the information is the user associated with the user profile. This is a lengthy and time-consuming process for the user and the lender. Moreover, and as noted above, due to a potential time gap between the time that the user is engaged in the application process and the time in which the lender makes a decision or determines that additional information is needed, the user loses interests, or for other reasons, does not complete the loan process. In combination, the disclosed method does not represent merely gathering data for comparison or security purposes, but instead sets up a sequence of events that addresses unique problems associated with lenders and loan applications (e.g., the time taken to complete the process and the memory, processing load, etc. required to identify and verify user data). Thus, the system 10 and/or the methods disclosed present a specific, discrete way in which a loan application is processed and approved. Further, the combination of verifying—using accessible records to the lender—that the number of the mobile phone is associated with the user and verifying—by sending a PIN to the mobile phone—that the user is in possession of the mobile phone does not merely select information by content or source, but instead is a process that differs from the routine and conventional sequence of events.

In one embodiment, the system 10 and/or the methods disclosed transform the GUI 15e into a specific, structured GUI and pair with it a prescribed functionality directly related to the GUI's structure that is addressed to and resolves a specifically identified problem in the conventional loan processing systems. That is, the use of radio buttons and drop-down menus reduce the likelihood of data entry errors and the use of two-factor authentication quickly confirm the user's identity, which together and in combination, allow for a single-session real-time loan application and approval process. This improves the accuracy of lending decisions and increases the percentage of loan applications that are completed. As noted above, due to the time gaps in the conventional lending process, the user may become disengaged from the process. Reinitiating a lending-user session is often too burdensome for some users. Thus, the single-session, real-time loan application and approval process reduces the time gap to a matter of seconds or minutes. Regardless, the time required to complete the loan application and approval process is such that the user remains engaged in the process and completes the process in one session. Moreover, when one or more of the windows are displayed on the GUI 15e, the GUI is transformed into a specific, structured GUI that reduces the data associated with electronic text inputs.

In one embodiment, the system 10 and/or methods disclosed herein result in the following advances over conventional systems and methods: 1) just three pieces of information on the consumer (in most cases) enables the customer identity to be verified, vehicle information to be pulled, and the credit file of the user to identified; 2) auto-population of a loan application with information associated with the credit file of the user identified reduces the number of inputs required by the user and received by a computer; and 3) two-factor authentication of the user via the PIN number being sent to the user's phone prevents identity fraud. These advances result in one or more of the following: 1) an improvement to the functioning of the computer (i.e., remote user device 15 and the computer 25) itself in that the information normally entered to complete an application via the remote user device 15 is not required to be entered, 2) an improvement to the efficiency of the computer (i.e., the remote user device 15 and/or the computer 25) itself in that fewer screens are displayed to receive information normally entered to complete an application and in that fewer text inputs are received by the remote user device 15 and/or the computer 25 to complete an application; and 3) solves a technological problem relating to proving the identity of a user when the user is submitting an application electronically without a face-to-face meeting with a loan officer and a technological problem relating to the time required to verify an applicant's identity in electronically submitted loan applications.

Regarding the improvement to the functioning of the remote user device 15 and/or the computer 25, the display of windows 90, 140, 145, 150, 160, 180, 255, 260, 270, 280, 285, 295, 300, and 305 and the information received and displayed thereon improves the functioning of the remote user device 15 and/or the computer 25. That is, the requirement for displaying screens and sub screens to receive textual inputs relating to information that is now auto-populated to the loan application is eliminated, which reduces the processing load compared to the remote user device 15 and/or the computer 25 needing to present these screens and sub screens and/or receive textual inputs relating to the information that is auto-populated to the loan application. Reducing the processing load of the remote user device 15 and/or the computer 25 generally improves the performance of the remote user device 15 and/or the computer 25 such that the available memory of the remote user device 15 and/or the computer 25 is increased, the processing capacity of the remote user device 15 and/or the computer 25 is increased therefore making the remote user device 15 and/or the computer 25 operate more efficiently, and the processing speed of the remote user device 15 and/or the computer 25 is increased. Thus, the system 10 and methods disclosed improve the functioning of the remote user device 15 and/or the computer 25 itself. That is, the system 10 results in specific improvements in computer capabilities (i.e., reduction of required memory and reduction of processing load).

As used herein, the term “real-time” is thus meant to encompass close to real-time, such as within about 10 seconds, preferably within about 5 seconds, and more preferably within about 2 seconds. “Real-time” can also encompass an amount of time that is required to transmit the information via the internet using traditional connection speeds.

As used here, “auto-populate” is thus meant to encompass identifying relevant information within a credit profile and storing said relevant information in association with a loan application. In some embodiments, the term “auto-populate” includes mapping the location of relevant information within a credit profile to a specific query or portion of the loan application. That is, the loan application is not limited to a traditional fillable form having spaces that automatically display information that was previously associated with the applicant's credit profile. Instead, auto-populate or auto-populating can include merely the reference to relevant information within the credit profile without copying or transcribing that information to another location.

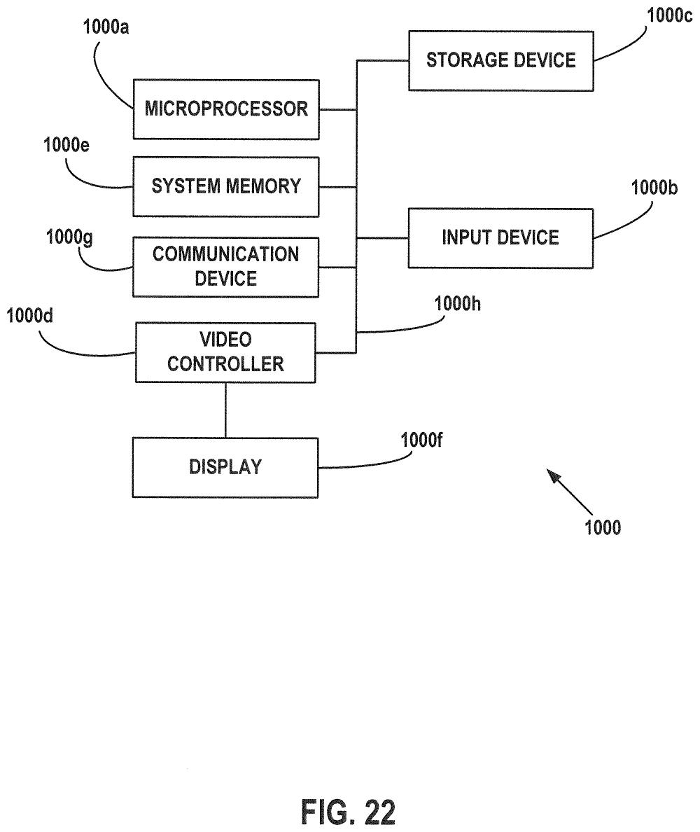

In an example embodiment, as illustrated in FIG. 22 with continuing reference to FIGS. 1-21 and Appendix A, an illustrative node 1000 for implementing one or more of the example embodiments described above, illustrated in FIGS. 1-21, described and/or illustrated in Appendix A, and/or any combination thereof, is depicted. The node 1000 includes a microprocessor 1000a, an input device 1000b, a storage device 1000c, a video controller 1000d, a system memory 1000e, a display 1000f, and a communication device 1000g all interconnected by one or more buses 1000h. In several example embodiments, the storage device 1000c may include a floppy drive, hard drive, CD-ROM, optical drive, any other form of storage device and/or any combination thereof. In several example embodiments, the storage device 1000c may include, and/or be capable of receiving, a floppy disk, CD-ROM, DVD-ROM, or any other form of computer-readable medium that may contain executable instructions. In several example embodiments, the communication device 1000g may include a modem, network card, or any other device to enable the node to communicate with other nodes. In several example embodiments, any node represents a plurality of interconnected (whether by intranet or Internet) computer systems, including without limitation, personal computers, mainframes, PDAs, smartphones and cell phones.

In several example embodiments, one or more of the components of the systems described above, illustrated in FIGS. 1-21, described and/or illustrated in Appendix A, and/or any combination thereof, include at least the node 1000 and/or components thereof, and/or one or more nodes that are substantially similar to the node 1000 and/or components thereof. In several example embodiments, one or more of the above-described components of the node 1000, the system 10, and/or the example embodiments described and illustrated in Appendix A include respective pluralities of same components.

In several example embodiments, one or more of the applications, systems, and application programs described above, illustrated in FIGS. 1-21, described and/or illustrated Appendix A, and/or any combination thereof, include a computer program that includes a plurality of instructions, data, and/or any combination thereof; an application written in, for example, Arena, HyperText Markup Language (HTML), Cascading Style Sheets (CSS), JavaScript, Extensible Markup Language (XML), asynchronous JavaScript and XML (Ajax), and/or any combination thereof; a web-based application written in, for example, Java or Adobe Flex, which in several example embodiments pulls real-time information from one or more servers, automatically refreshing with latest information at a predetermined time increment; or any combination thereof.

In several example embodiments, a computer system typically includes at least hardware capable of executing machine readable instructions, as well as the software for executing acts (typically machine-readable instructions) that produce a desired result. In several example embodiments, a computer system may include hybrids of hardware and software, as well as computer sub-systems.

In several example embodiments, hardware generally includes at least processor-capable platforms, such as client-machines (also known as personal computers or servers), and hand-held processing devices (such as smart phones, tablet computers, personal digital assistants (PDAs), or personal computing devices (PCDs), for example). In several example embodiments, hardware may include any physical device that is capable of storing machine-readable instructions, such as memory or other data storage devices. In several example embodiments, other forms of hardware include hardware sub-systems, including transfer devices such as modems, modem cards, ports, and port cards, for example.

In several example embodiments, software includes any machine code stored in any memory medium, such as RAM or ROM, and machine code stored on other devices (such as floppy disks, flash memory, or a CD ROM, for example). In several example embodiments, software may include source or object code. In several example embodiments, software encompasses any set of instructions capable of being executed on a node such as, for example, on a client machine or server.

In several example embodiments, combinations of software and hardware could also be used for providing enhanced functionality and performance for certain embodiments of the present disclosure. In an example embodiment, software functions may be directly manufactured into a silicon chip. Accordingly, it should be understood that combinations of hardware and software are also included within the definition of a computer system and are thus envisioned by the present disclosure as possible equivalent structures and equivalent methods.

In several example embodiments, computer readable mediums include, for example, passive data storage, such as a random access memory (RAM) as well as semi-permanent data storage such as a compact disk read only memory (CD-ROM). One or more example embodiments of the present disclosure may be embodied in the RAM of a computer to transform a standard computer into a new specific computing machine. In several example embodiments, data structures are defined organizations of data that may enable an embodiment of the present disclosure. In an example embodiment, a data structure may provide an organization of data, or an organization of executable code.

In several example embodiments, any networks and/or one or more portions thereof may be designed to work on any specific architecture. In an example embodiment, one or more portions of any networks may be executed on a single computer, local area networks, client-server networks, wide area networks, internets, hand-held and other portable and wireless devices and networks.

In several example embodiments, a database may be any standard or proprietary database software. In several example embodiments, the database may have fields, records, data, and other database elements that may be associated through database specific software. In several example embodiments, data may be mapped. In several example embodiments, mapping is the process of associating one data entry with another data entry. In an example embodiment, the data contained in the location of a character file can be mapped to a field in a second table. In several example embodiments, the physical location of the database is not limiting, and the database may be distributed. In an example embodiment, the database may exist remotely from the server, and run on a separate platform. In an example embodiment, the database may be accessible across the Internet. In several example embodiments, more than one database may be implemented.

In several example embodiments, a plurality of instructions stored on a non-transitory computer readable medium may be executed by one or more processors to cause the one or more processors to carry out or implement in whole or in part the above-described operation of each of the above-described example embodiments of the system, the method, and/or any combination thereof. In several example embodiments, such a processor may include one or more of the microprocessor 1000a, any processor(s) that are part of the components of the system, and/or any combination thereof, and such a computer readable medium may be distributed among one or more components of the system. In several example embodiments, such a processor may execute the plurality of instructions in connection with a virtual computer system. In several example embodiments, such a plurality of instructions may communicate directly with the one or more processors, and/or may interact with one or more operating systems, middleware, firmware, other applications, and/or any combination thereof, to cause the one or more processors to execute the instructions.

The present disclosure introduces a method of completing a secure loan application for a financial institution by authenticating a customer's identity which includes obtaining customer-specific information from the user via a first window displayed on a graphical user interface; wherein the customer-specific information consists of: a mobile phone number associated with the user; a first name of the user; a last name of the user; and a portion of the user's social security number; comparing, by a processor, the obtained customer-specific information with customer information from a credit bureau to verify the customer's identity by: determining whether the mobile phone number provided by the user is associated with the user based on records accessible by the credit bureau; generating a random code and transmitting it to a mobile communication device using the mobile phone number; and receiving the random code via a second window displayed on the graphical user interface; wherein verifying the customer's identity creates at least a portion of the secure loan application; displaying, by a processor, asset(s) associated with the user based on the records accessible by the credit bureau; receiving, by a processor, a selection of an asset from the user; wherein receiving a selection of the asset completes another portion of the secure loan application; and determining, based on the customer information from the credit bureau, the portion of the secure loan application, and the another portion of the secure loan application, whether the user is approved for a loan.

The present disclosure also introduces a method that includes: providing a graphical user interface, wherein the graphical user interface is adapted to display a first, second, third, and fourth dialogue box and a graphical control element within a first window; wherein the first dialogue box is configured to receive a user first name; wherein the second dialogue box is configured to receive a user last name; wherein the third dialogue box is configured to receive a user phone number; wherein the fourth dialogue box is configured to receive a portion of a personal identification number associated with the user; and wherein the graphical control element is configured to display a list of income ranges; after displaying the first window, receiving by a processor, user information data from the first, second, and fourth dialogue boxes and the graphical control element, wherein the user information data consists of: first name data received via the first dialogue box; last name data received via the second dialogue box; user phone number data received via the third dialogue box; a portion of a personal identification number received via the fourth dialogue box; and an income range received via the graphical control element; matching at least a portion of the user information data with a user profile and classifying the user as “provisionally identified”; wherein the user profile associates the user with one or more vehicles; sending a PIN number to a mobile device associated with the phone number provided via the third dialogue box; displaying a fifth dialogue box on a second window that is different from the first window, wherein the fifth dialogue box is configured to receive the PIN; upon receiving the PIN via the fifth dialogue box, displaying the one or more vehicles associated with the user profile in a third window that is different from the first and second windows; and receiving an indication of a selected vehicle from the one or more vehicles and changing the classification of the user from provisionally identified to identity confirmed.

The present disclosure also introduces a method of electronically processing a loan application, the method including: (a) receiving, via a computer system, identifying information for an applicant of the loan application; (b) matching, in real time and via the computer system, the identifying information with a potential identity within a credit bureau; (c) authenticating, using a two-factor authentication method and the computer system, that the potential identity within the credit bureau is associated with the applicant; and (d) auto-populating the loan application with information from the potential identity within the credit bureau. In one embodiment, the method also includes (e) processing the loan application; wherein the steps of (a), (b), (c), (d), and (e) occur within a single online session. In one embodiment, the single online session has a duration of less than 5 minutes. In one embodiment, the identifying information for the applicant includes a mobile phone number; and wherein authenticating, using the two-factor authentication method, that the potential identity within the credit bureau is associated with the applicant includes: determining whether the mobile phone number provided is associated with the applicant based on records accessible by the credit bureau; generating a random code and transmitting it to a mobile communication device using the mobile phone number; and receiving the random code via the computer system. In one embodiment, auto-populating the loan application with information from the potential identity includes associating the information from the potential identity with the loan application without the applicant entering the information into the computer system. In one embodiment, the method also includes displaying a plurality of assets to the applicant, wherein one of the assets from the plurality of assets is associated with the potential identity within the credit bureau; and receiving a selection from the applicant, wherein the selection is the one of the assets associated with the potential identity within the credit bureau; and wherein the step (e) occurs after receiving the selection from the applicant. In one embodiment, the plurality of assets includes a vehicle; wherein the selection from the applicant is the vehicle; and wherein the loan application is for a loan to repair the vehicle. In one embodiment, the method also includes (f) approving the applicant for a loan; and (g) notifying the applicant, via the computer system, that the applicant is approved for the loan; wherein the steps (f) and (g) occur within the single online session. In one embodiment, the method also includes (h) receiving an electronically executed loan agreement from the applicant; and (i) distributing funds associated with the loan to the applicant; wherein the steps (h) and (i) occur within the single online session.

The present disclosure also introduces a method of completing a secure loan application for a financial institution by authenticating a customer's identity, including the steps of: (a) obtaining customer-specific information from the user via a first window displayed on a graphical user interface; wherein the customer-specific information consists of: a mobile phone number associated with the user; a first name of the user; a last name of the user; and a portion of a government-issued identification number of the user; (b) comparing, by a processor, the obtained customer-specific information with customer information from a credit bureau to verify the customer's identity by: determining whether the mobile phone number provided by the user is associated with the user based on records accessible by the credit bureau; generating a random code and transmitting it to a mobile communication device using the mobile phone number; and receiving the random code via a second window displayed on the graphical user interface; wherein verifying the customer's identity creates at least a portion of the secure loan application; (c) displaying, by the processor, asset(s) associated with the user based on the records accessible by the credit bureau; (d) receiving, by the processor, a selection of an asset from the user; wherein receiving the selection of the asset completes another portion of the secure loan application; and (e) determining whether the user is approved for a loan based on the customer information from the credit bureau, the portion of the secure loan application, and the another portion of the secure loan application. In one embodiment, the asset(s) associated with the user based on the records accessible by the credit bureau includes a listing of vehicles; wherein the selection from the user is one vehicle from the listing of vehicles; and wherein the loan is for repair of the selected vehicle. In one embodiment, the steps of (a), (b), (c), (d), and (e) occur within a single online session. In one embodiment, the single online session has a duration of less than 5 minutes. In one embodiment, the method also includes: (f) approving the user for the loan; and (g) notifying the user, via a third window displayed on the graphical user interface, that the user is approved for the loan; wherein the steps (f) and (g) occur within a single online session. In one embodiment, the method also includes: (h) receiving an electronically executed loan agreement from the user; and (i) distributing funds associated with the loan; wherein the steps (h) and (i) occur within the single online session. In one embodiment, the loan application is for a vehicle repair; and wherein the step (i) includes distributing the funds to the user via a virtual card.

The present disclosure also introduces a method including: (a) providing a graphical user interface, wherein the graphical user interface is adapted to display a first, second, third, and fourth dialogue box and a graphical control element within a first window; wherein the first dialogue box is configured to receive a user first name; wherein the second dialogue box is configured to receive a user last name; wherein the third dialogue box is configured to receive a user phone number; wherein the fourth dialogue box is configured to receive a portion of a personal identification number associated with the user; and wherein the graphical control element is configured to display a list of income ranges; (b) after displaying the first window, receiving by a processor, user information data from the first, second, and fourth dialogue boxes and the graphical control element, wherein the user information data consists of: first name data received via the first dialogue box; last name data received via the second dialogue box; user phone number data received via the third dialogue box; a portion of a personal identification number received via the fourth dialogue box; and an income range received via the graphical control element; (c) matching at least a portion of the user information data with a user profile and classifying the user as “provisionally identified”; wherein the user profile associates the user with one or more vehicles; (d) sending a PIN number to a mobile device associated with the phone number provided via the third dialogue box; (e) displaying a fifth dialogue box on a second window that is different from the first window, wherein the fifth dialogue box is configured to receive the PIN number; (f) upon receiving the PIN number via the fifth dialogue box, displaying the one or more vehicles associated with the user profile in a third window that is different from the first and second windows; and (g) receiving an indication of a selected vehicle from the one or more vehicles and changing the classification of the user from provisionally identified to identity confirmed. In one embodiment, the steps of (a)-(g) occur within a single online session. In one embodiment, the single online session has a duration of less than 5 minutes. In one embodiment, the method also includes: (h) auto-populating a loan application with information from the user profile having the classification of identity confirmed; and (i) determining whether the user is approved for a loan based on the loan application.

In several example embodiments, the elements and teachings of the various illustrative example embodiments may be combined in whole or in part in some or all of the illustrative example embodiments. In addition, one or more of the elements and teachings of the various illustrative example embodiments may be omitted, at least in part, and/or combined, at least in part, with one or more of the other elements and teachings of the various illustrative embodiments.

Any spatial references such as, for example, “upper,” “lower,” “above,” “below,” “between,” “bottom,” “vertical,” “horizontal,” “angular,” “upwards,” “downwards,” “side-to-side,” “left-to-right,” “right-to-left,” “top-to-bottom,” “bottom-to-top,” “top,” “bottom,” “bottom-up,” “top-down,” etc., are for the purpose of illustration only and do not limit the specific orientation or location of the structure described above.

In several example embodiments, while different steps, processes, and procedures are described as appearing as distinct acts, one or more of the steps, one or more of the processes, and/or one or more of the procedures may also be performed in different orders, simultaneously and/or sequentially. In several example embodiments, the steps, processes and/or procedures may be merged into one or more steps, processes and/or procedures.

In several example embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

Although several example embodiments have been described in detail above, the embodiments described are example only and are not limiting, and those skilled in the art will readily appreciate that many other modifications, changes and/or substitutions are possible in the example embodiments without materially departing from the novel teachings and advantages of the present disclosure. Accordingly, all such modifications, changes and/or substitutions are intended to be included within the scope of this disclosure as defined in the following claims. In the claims, any means-plus-function clauses are intended to cover the structures described herein as performing the recited function and not only structural equivalents, but also equivalent structures. Moreover, it is the express intention of the applicant not to invoke 35 U.S.C. § 112, paragraph 6 for any limitations of any of the claims herein, except for those in which the claim expressly uses the word “means” together with an associated function.

What is claimed is:

1. A method of electronically processing a loan application, the method comprising:
(a) receiving, via a computer system, identifying information for an applicant of the loan application;
(b) matching, in real time and via the computer system, the identifying information with a potential identity within a credit bureau;
(c) authenticating, using a two-factor authentication method and the computer system, that the potential identity within the credit bureau is associated with the applicant; and
(d) auto-populating the loan application with information from the potential identity within the credit bureau.

2. The method of claim 1, further comprising (e) processing the loan application; wherein the steps of (a), (b), (c), (d), and (e) occur within a single online session.

3. The method of claim 2, wherein the single online session has a duration of less than 5 minutes.

4. The method of claim 1,
wherein the identifying information for the applicant includes a mobile phone number; and
wherein authenticating, using the two-factor authentication method, that the potential identity within the credit bureau is associated with the applicant comprises:
determining that the mobile phone number is associated with the applicant based on records accessible by the credit bureau;
generating a random code and transmitting it to a mobile communication device using the mobile phone number; and
receiving the random code via the computer system.

5. The method of claim 1, wherein auto-populating the loan application with information from the potential identity comprises associating the information from the potential identity with the loan application without the applicant entering the information into the computer system.

6. The method of claim 2, further comprising:
displaying a plurality of assets to the applicant, wherein one of the assets from the plurality of assets is associated with the potential identity within the credit bureau; and
receiving a selection from the applicant, wherein the selection is the one of the assets associated with the potential identity within the credit bureau; and
wherein the step (e) occurs after receiving the selection from the applicant.

7. The method of claim 6,
wherein the plurality of assets includes a vehicle;
wherein the selection from the applicant is the vehicle; and
wherein the loan application is for a loan to repair the vehicle.

8. The method of claim 2, further comprising:
(f) approving the applicant for a loan; and
(g) notifying the applicant, via the computer system, that the applicant is approved for the loan;
wherein the steps (f) and (g) occur within the single online session.

9. The method of claim 8, further comprising:
(h) receiving an electronically executed loan agreement from the applicant; and
(i) distributing funds associated with the loan to the applicant;
wherein the steps (h) and (i) occur within the single online session.

10. A method of completing a secure loan application for a financial institution by authenticating a customer's identity, comprising the steps of:
(a) obtaining customer-specific information from the user via a first window displayed on a graphical user interface;
wherein the customer-specific information consists of:
a mobile phone number associated with the user;
a first name of the user;
a last name of the user; and
a portion of a government-issued identification number of the user;
(b) comparing, by a processor, the obtained customer-specific information with customer information from a credit bureau to verify the customer's identity by:
determining that the mobile phone number is associated with the user based on records accessible by the credit bureau;
generating a random code and transmitting it to a mobile communication device using the mobile phone number; and
receiving the random code via a second window displayed on the graphical user interface;
wherein verifying the customer's identity creates at least a portion of the secure loan application;
(c) displaying, by the processor, asset(s) associated with the user based on the records accessible by the credit bureau;
(d) receiving, by the processor, a selection of an asset from the user;
wherein receiving the selection of the asset completes another portion of the secure loan application;
and
(e) determining whether the user is approved for a loan based on the customer information from the credit bureau, the portion of the secure loan application, and the another portion of the secure loan application.

11. The method of claim 10,
wherein the asset(s) associated with the user based on the records accessible by the credit bureau includes a listing of vehicles;
wherein the selection from the user is one vehicle from the listing of vehicles; and
wherein the loan is for repair of the selected vehicle.

12. The method of claim 10, wherein the steps of (a), (b), (c), (d), and (e) occur within a single online session.

13. The method of claim 12, wherein the single online session has a duration of less than 5 minutes.

14. The method of claim 10, further comprising:
(f) approving the user for the loan; and
(g) notifying the user, via a third window displayed on the graphical user interface, that the user is approved for the loan;
wherein the steps (f) and (g) occur within a single online session.

15. The method of claim 14, further comprising:
(h) receiving an electronically executed loan agreement from the user; and
(i) distributing funds associated with the loan;
wherein the steps (h) and (i) occur within the single online session.

16. The method of claim 15,
wherein the loan application is for a vehicle repair; and
wherein the step (i) comprises distributing the funds to the user via a virtual card.

17. A method comprising:
(a) providing a graphical user interface, wherein the graphical user interface is adapted to display a first, second, third, and fourth dialogue box and a graphical control element within a first window;
wherein the first dialogue box is configured to receive a user first name;
wherein the second dialogue box is configured to receive a user last name;
wherein the third dialogue box is configured to receive a user phone number;
wherein the fourth dialogue box is configured to receive a portion of a personal identification number associated with the user; and
wherein the graphical control element is configured to display a list of income ranges;
(b) after displaying the first window, receiving by a processor, user information data from the first, second, and fourth dialogue boxes and the graphical control element, wherein the user information data consists of: first name data received via the first dialogue box; last name data received via the second dialogue box; user phone number data received via the third dialogue box; a portion of a personal identification number received via the fourth dialogue box; and an income range received via the graphical control element;
(c) matching at least a portion of the user information data with a user profile and classifying the user as “provisionally identified”;
wherein the user profile associates the user with one or more vehicles;
(d) sending a PIN number to a mobile device associated with the phone number provided via the third dialogue box;
(e) displaying a fifth dialogue box on a second window that is different from the first window, wherein the fifth dialogue box is configured to receive the PIN number;
(f) upon receiving the PIN number via the fifth dialogue box, displaying the one or more vehicles associated with the user profile in a third window that is different from the first and second windows; and
(g) receiving an indication of a selected vehicle from the one or more vehicles and changing the classification of the user from provisionally identified to identity confirmed.

18. The method of claim 17, wherein the steps of (a)-(g) occur within a single online session.

19. The method of claim 18, wherein the single online session has a duration of less than 5 minutes.

20. The method of claim 17, further comprising:
(h) auto-populating a loan application with information from the user profile having the classification of identity confirmed; and
(i) determining whether the user is approved for a loan based on the loan application.
